(19) United States
(12) Patent Application Publication
(10) Pub. No.: US 2025/0224363 A1
(43) Pub. Date: Jul. 10, 2025

(54) GAS SENSOR, AND CONCENTRATION MEASUREMENT METHOD USING GAS SENSOR

(71) Applicant: NGK INSULATORS, LTD., Nagoya-shi (JP)

(72) Inventors: Yusuke WATANABE, Nagoya-shi (JP); Daichi ICHIKAWA, Nagoya-shi (JP)

(21) Appl. No.: 19/089,325

(22) Filed: Mar. 25, 2025

Related U.S. Application Data
(63) Continuation of application No. PCT/JP2023/029983, filed on Aug. 21, 2023.

(30) Foreign Application Priority Data
Sep. 29, 2022 (JP) 2022-156715

(51) Int. Cl. G01N 27/41; G01M 15/10; G01N 27/406; G01N 27/407

(52) U.S. Cl. CPC G01N 27/41; G01M 15/104; G01N 27/4067; G01N 27/4075

(57) ABSTRACT

A sensor element includes: first to third chambers communicating sequentially from a gas inlet; and a heater performing heating so that a temperature is highest near the first chamber, a first adjustment pump cell pumps oxygen out of a measurement gas introduced into the first chamber to the extent that H₂O and CO₂ are not decomposed, a second adjustment pump cell pumps out oxygen from the second chamber so that all H₂O and CO₂ are reduced, a first measurement pump cell pumps oxygen into the third chamber to selectively oxidize H₂ near the first measurement electrode, a second measurement pump cell pumps oxygen into the third chamber to oxidize H₂ and CO near the second measurement electrode, concentrations of H₂O and CO₂ are identified from values of currents generated by pumping-in by these measurement pump cells.

### CROSS-REFERENCE TO RELATED APPLICATION

This application is a continuation application of PCT/JP2023/029983, filed on Aug. 21, 2023, which claims the benefit of priority of Japanese Patent Application No. JP2022-156715, filed on Sep. 29, 2022, the entire contents of which are incorporated herein by reference.

### BACKGROUND

### Technical Field

The present invention relates to a multi-gas sensor capable of sensing a plurality of types of sensing target gas components and measuring concentrations thereof.

### Description of the Background Art

In measurement for managing the amount of an emitted exhaust gas from a vehicle, technology of measuring concentrations of water vapor (H₂O) and carbon dioxide (CO₂) has already been known (see Japanese Patent No. 5918177, No. 6469464, and No. 6469462, for example). In each of gas sensors disclosed in Japanese Patent No. 5918177 and No. 6469464, a water vapor (H₂O) component and a carbon dioxide (CO₂) component can be measured in parallel. As for a gas sensor disclosed in Japanese Patent No. 6469462, a water vapor (H₂O) component can accurately be measured even when a measurement gas contains carbon dioxide (CO₂).

In the gas sensor disclosed in Japanese Patent No. 5918177 having a three-chamber configuration, firstly, a main pump cell as a pump cell for a first internal space operates to pump out O₂ contained in a measurement gas introduced into the first internal space and to reduce all H₂O and CO₂ similarly contained in the measurement gas once to generate H₂ and CO. The measurement gas containing these H₂ and CO is introduced into a second internal space and further into a third internal space. A first measurement pump cell as a pump cell for the second internal space then pumps in O₂ to selectively oxidize H₂ to generate H₂O, and, further, a second measurement pump cell as a pump cell for the third internal space pumps in O₂ to oxidize CO to generate CO₂. Concentrations of H₂O and CO₂ in the measurement gas are respectively measured based on magnitudes of pump currents flowing through the first measurement pump cell and the second measurement pump cell when H₂ and CO are oxidized.

In the gas sensor, an applied voltage in the pump cell for the first internal space is required to be set to be high for reduction of H₂O and CO₂ in the first internal space. In addition, a temperature of a main inner pump electrode as an in-space pump electrode forming the main pump cell is required to be set to be high. Such a high applied voltage and maintaining the pump electrode at a high temperature, however, might cause a sensor element containing oxygen-ion conductive solid electrolyte ceramics as a major component to be cracked and blackened to reduce the solid electrolyte ceramics.

In the gas sensor disclosed in Japanese Patent No. 6469462 having a two-chamber configuration, for improvement in selective H₂ oxidation property, an alloy of Au and another noble metal (e.g., Pt, Rh, and Ru) is used as a material for a measurement inner pump electrode as an in-space pump electrode forming a measurement pump cell as a pump cell for a second internal space, and an abundance ratio of Au in a surface of the electrode is 25 at % or more.

This material for the electrode is seemingly applicable to a first measurement inner pump electrode of the first measurement pump cell selectively oxidizing H₂ similarly in the gas sensor disclosed in Japanese Patent No. 5918177.

The first measurement inner pump electrode, however, is provided at a location to be at a higher temperature than a second measurement inner pump electrode as an in-space pump electrode forming the second measurement pump cell in the gas sensor disclosed in Japanese Patent No. 5918177, so that use of such a material for the electrode might cause evaporation of Au in the electrode to change sensitivity during a long-term use.

### SUMMARY

The present invention relates to a multi-gas sensor capable of sensing a plurality of types of sensing target gas components and measuring concentrations thereof.

According to the present invention, a gas sensor capable of measuring concentrations of a plurality of sensing target gas components contained in a measurement gas, the measurement gas at least containing water vapor and carbon dioxide, the gas sensor includes: a sensor element having a structure formed of an oxygen-ion conductive solid electrolyte; and a controller controlling operation of the gas sensor, wherein the sensor element includes: a gas inlet through which the measurement gas is introduced; an internal chamber communicating with the gas inlet via a diffusion control part; a first adjustment electrode, a second adjustment electrode, and a set of a first measurement electrode and a second measurement electrode each provided to face the internal chamber and arranged in order of proximity to the gas inlet while being spaced apart at predetermined intervals, the first measurement electrode and the second measurement electrode being provided at locations equivalent to each other with respect to a flow of the measurement gas flowing into the internal chamber; a first adjustment pump cell including the first adjustment electrode, an out-of-space pump electrode provided at a location other than a location in the internal chamber, and a portion of the solid electrolyte present between the first adjustment electrode and the out-of-space pump electrode; a second adjustment pump cell including the second adjustment electrode, the out-of-space pump electrode, and a portion of the solid electrolyte present between the second adjustment electrode and the out-of-space pump electrode; a first measurement pump cell including the first measurement electrode, the out-of-space pump electrode, and a portion of the solid electrolyte present between the first measurement electrode and the out-of-space pump electrode; a second measurement pump cell including the second measurement electrode, the out-of-space pump electrode, and a portion of the solid electrolyte present between the second measurement electrode and the out-of-space pump electrode; and a heater heating the sensor element, the first measurement electrode is a cermet electrode containing a Pt—Au alloy as a metal component, the heater heats the sensor element so that a temperature is highest near the first adjustment electrode in the internal chamber and decreases with increasing distance from the first adjustment electrode in a longitudinal direction of the sensor element, the first adjustment pump cell pumps oxygen out of the measurement gas having reached the first adjustment electrode through the gas inlet to the extent that water vapor and carbon dioxide contained in the measurement gas are not decomposed, the second adjustment pump cell pumps oxygen out of the measurement gas having reached the second adjustment electrode so that substantially all water vapor and carbon dioxide contained in the measurement gas of which oxygen has been pumped out by the first adjustment pump cell are reduced, the first measurement pump cell pumps oxygen into the internal chamber to selectively oxidize, near the first measurement electrode, hydrogen generated by reduction of water vapor and contained in the measurement gas having reached the first measurement electrode, the second measurement pump cell pumps oxygen into the internal chamber to oxidize, near the second measurement electrode, hydrogen and carbon monoxide respectively generated by reduction of water vapor and carbon dioxide and contained in the measurement gas having reached the second measurement electrode, and the controller identifies: a concentration of water vapor contained in the measurement gas based on a value of a selective oxidation current as an oxygen pump current flowing between the first measurement electrode and the out-of-space pump electrode when hydrogen near the first measurement electrode is selectively oxidized by the first measurement pump cell pumping in oxygen; and a concentration of carbon dioxide contained in the measurement gas based on the value of the selective oxidation current and a value of a double-oxidation current as an oxygen pump current flowing between the second measurement electrode and the out-of-space pump electrode when hydrogen and carbon monoxide near the second measurement electrode are oxidized by the second measurement pump cell pumping in oxygen.

Another aspect of the present invention is a concentration measurement method of measuring concentrations of a plurality of sensing target gas components contained in a measurement gas using a gas sensor, the measurement gas at least containing water vapor and carbon dioxide, wherein the gas sensor includes a sensor element having an elongated planar structure formed of an oxygen-ion conductive solid electrolyte, the sensor element includes: a gas inlet through which the measurement gas is introduced; an internal chamber communicating with the gas inlet via a diffusion control part; a first adjustment electrode, a second adjustment electrode, and a set of a first measurement electrode and a second measurement electrode each provided to face the internal chamber and arranged in order of proximity to the gas inlet while being spaced apart at predetermined intervals, the first measurement electrode and the second measurement electrode being provided at locations equivalent to each other with respect to a flow of the measurement gas flowing into the internal chamber; a first adjustment pump cell including the first adjustment electrode, an out-of-space pump electrode provided at a location other than a location in the internal chamber, and a portion of the solid electrolyte present between the first adjustment electrode and the out-of-space pump electrode; a second adjustment pump cell including the second adjustment electrode, the out-of-space pump electrode, and a portion of the solid electrolyte present between the second adjustment electrode and the out-of-space pump electrode; a first measurement pump cell including the first measurement electrode, the out-of-space pump electrode, and a portion of the solid electrolyte present between the first measurement electrode and the out-of-space pump electrode; a second measurement pump cell including the second measurement electrode, the out-of-space pump electrode, and a portion of the solid electrolyte present between the second measurement electrode and the out-of-space pump electrode; and a heater heating the sensor element, the first measurement electrode is a cermet electrode containing a Pt—Au alloy as a metal component, and the concentration measurement method using the gas sensor includes: a) heating, using the heater, the sensor element so that a temperature is highest near the first adjustment electrode in the internal chamber and decreases with increasing distance from the first adjustment electrode in a longitudinal direction of the sensor element; b) pumping, using the first adjustment pump cell, oxygen out of the measurement gas having reached the first adjustment electrode through the gas inlet to the extent that water vapor and carbon dioxide contained in the measurement gas are not decomposed; c) pumping, using the second adjustment pump cell, oxygen out of the measurement gas having reached the second adjustment electrode so that substantially all water vapor and carbon dioxide contained in the measurement gas of which oxygen has been pumped out using the first adjustment pump cell are reduced; d) pumping, using the first measurement pump cell, oxygen into the internal chamber to selectively oxidize, near the first measurement electrode, hydrogen generated by reduction of water vapor and contained in the measurement gas having reached the first measurement electrode; e) pumping, using the second measurement pump cell, oxygen into the internal chamber to oxidize, near the second measurement electrode, hydrogen and carbon monoxide respectively generated by reduction of water vapor and carbon dioxide and contained in the measurement gas having reached the second measurement electrode; f) identifying a concentration of water vapor contained in the measurement gas based on a value of a selective oxidation current as an oxygen pump current flowing between the first measurement electrode and the out-of-space pump electrode when hydrogen near the first measurement electrode is selectively oxidized by pumping in oxygen using the first measurement pump cell; and g) identifying a concentration of carbon dioxide contained in the measurement gas based on the value of the selective oxidation current and a value of a double-oxidation current as an oxygen pump current flowing between the second measurement electrode and the out-of-space pump electrode when hydrogen and carbon monoxide near the second measurement electrode are oxidized by pumping in oxygen using the second measurement pump cell.

According to the present invention, a multi-gas sensor with more long-term reliability than before suppressing cracking and blackening of a sensor element and suppressing evaporation of Au from an electrode is implemented.

It is therefore an object of the present invention to provide a multi-gas sensor with more long-term reliability than before capable of simultaneously measuring a water vapor (H₂O) component and a carbon dioxide (CO₂) component, suppressing cracking and blackening of a sensor element, and further being less likely to be subjected to a change in sensitivity during a long-term use.

### BRIEF DESCRIPTION OF THE DRAWINGS

FIG. 1 is a diagram schematically showing one example of a configuration of a gas sensor 100.

FIG. 2 is a block diagram showing functional components implemented by a controller 110.

FIG. 3 is a schematic diagram illustrating entry and exit of gases into and from three chambers comprised in a sensor element 101 of the gas sensor 100.

FIG. 4 is a graph showing a relationship between a target value of electromotive force V0 in a first chamber sensor cell 80 and an oxygen pump current Ip0 flowing through a first adjustment pump cell 21 when three different types of model gases are caused to flow.

FIG. 5 is a diagram illustrating a planar arrangement relationship between a first measurement electrode 44a and a second measurement electrode 44b in a sensor element 101A.

FIG. 6 is a diagram illustrating a planar arrangement relationship between a first measurement electrode 44a and a second measurement electrode 44b in a sensor element 101B.

FIG. 7 is a diagram illustrating a planar arrangement relationship between a first measurement electrode 44a and a second measurement electrode 44b in a sensor element 101C.

FIG. 8 is a diagram schematically showing one example of a configuration of a gas sensor 200 according to a modification.

### DESCRIPTION OF THE PREFERRED EMBODIMENTS

### <Configuration of Gas Sensor>

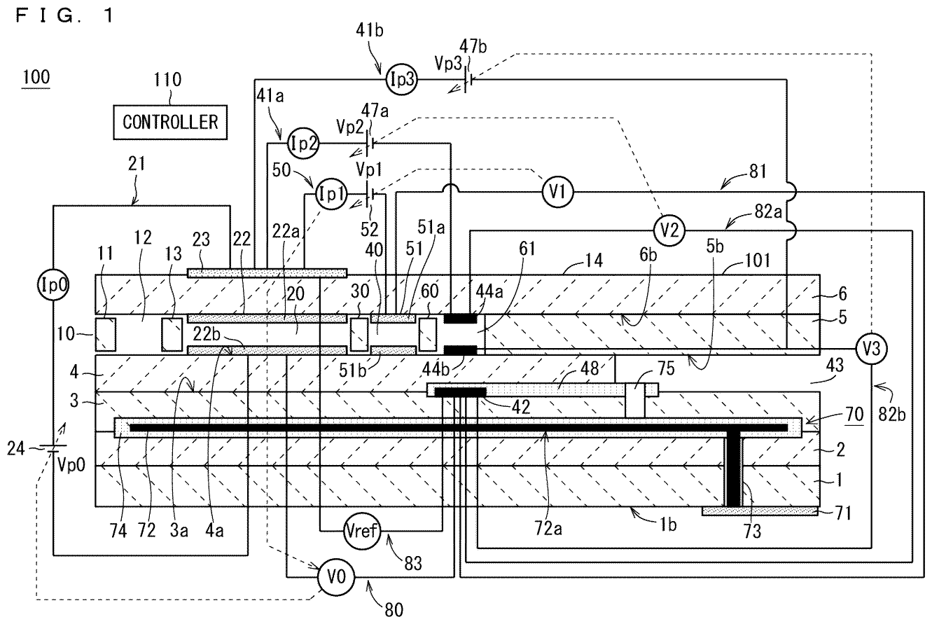

FIG. 1 is a diagram schematically showing one example of a configuration of a gas sensor 100 according to the present embodiment. The gas sensor 100 is a multi-gas sensor sensing a plurality of types of gas components and measuring concentrations thereof using a sensor element 101. Assume that at least water vapor (H₂O) and carbon dioxide (CO₂) are main sensing target gas components of the gas sensor 100 in the present embodiment. The gas sensor 100 is attached to an exhaust path of an internal combustion engine, such as an engine of a vehicle, and is used with an exhaust gas flowing along the exhaust path as a measurement gas, for example. FIG. 1 includes a vertical cross-sectional view taken along a longitudinal direction of the sensor element 101.

The sensor element 101 includes an elongated planar structure (base part) 14 formed of an oxygen-ion conductive solid electrolyte, a first diffusion control part 11 doubling a gas inlet 10 which is formed in one end portion (a left end portion in the figure) of the structure 14 and through which the measurement gas is introduced, and a buffer space 12, a first chamber 20, a second chamber 40, and a third chamber 61 formed in the structure 14 and communicating sequentially from the gas inlet 10 (first diffusion control part 11). The buffer space 12 communicates with the gas inlet 10 (first diffusion control part 11). The first chamber 20 communicates with the buffer space 12 via a second diffusion control part 13. The second chamber 40 communicates with the first chamber 20 via a third diffusion control part 30. The third chamber 61 communicates with the second chamber 40 via a fourth diffusion control part 60.

The structure 14 is formed by laminating a plurality of substrates of ceramics, for example. Specifically, the structure 14 has a configuration in which six layers including a first substrate 1, a second substrate 2, a third substrate 3, a first solid electrolyte layer 4, a spacer layer 5, and a second solid electrolyte layer 6 are sequentially laminated from the bottom. Each layer is formed of an oxygen-ion conductive solid electrolyte, such as zirconia (ZrO₂).

The first diffusion control part 11 doubling as the gas inlet 10, the buffer space 12, the second diffusion control part 13, the first chamber 20, the third diffusion control part 30, the second chamber 40, the fourth diffusion control part 60, and the third chamber 61 are formed in this order between a lower surface 6b of the second solid electrolyte layer 6 and an upper surface 4a of the first solid electrolyte layer 4 on a side of the one end portion of the structure 14. A part extending from the gas inlet 10 to the third chamber 61 is also referred to as a gas distribution part.

The buffer space 12, the first chamber 20, the second chamber 40, and the third chamber 61 are formed to penetrate the spacer layer 5 in a thickness direction. The lower surface 6b of the second solid electrolyte layer 6 is exposed in upper portions in the figure of these chambers and the like, and the upper surface 4a of the first solid electrolyte layer 4 is exposed in lower portions in the figure of these chambers and the like. Side portions of these chambers and the like are each defined by the spacer layer 5 or any of the diffusion control parts. The first chamber 20, the second chamber 40, and the third chamber 61 each have a length (size in the longitudinal direction of the element) of 0.3 mm to 1.0 mm, for example, a width (size in a transverse direction of the element) of 0.5 mm to 30 mm, for example, and a height (size in a thickness direction of the element) of 50 μm to 200 μm, for example. These chambers, however, are not required to have the same size and may have different sizes.

The gas inlet 10 may similarly be formed to penetrate the spacer layer 5 in the thickness direction separately from the first diffusion control part 11. In this case, the first diffusion control part 11 is to be formed inside and adjacent to the gas inlet 10.

The first diffusion control part 11, the second diffusion control part 13, the third diffusion control part 30, and the fourth diffusion control part 60 each include two horizontally long slits. That is to say, they each have openings elongated in a direction perpendicular to the page of the figure in an upper portion and a lower portion in the figure thereof. The slits each have a length (size in the longitudinal direction of the element) of 0.2 mm to 1.0 mm, for example, a width of an opening (size in the transverse direction of the element) of 0.5 mm to 30 mm, for example, and a height of the opening (size in the thickness direction of the element) of 5 μm to 30 μm, for example.

The sensor element 101 includes a reference gas introduction space 43 in the other end portion (a right end portion in the figure) opposite the one end portion in which the gas inlet 10 is provided. The reference gas introduction space 43 is formed between an upper surface 3a of the third substrate 3 and a lower surface 5b of the spacer layer 5. A side portion of the reference gas introduction space 43 is defined by a side surface of the first solid electrolyte layer 4. Oxygen (O₂) and air are introduced into the reference gas introduction space 43 as reference gases, for example.

The gas inlet 10 (first diffusion control part 11) is a part opening to an external space, and the measurement gas is taken from the external space into the sensor element 101 through the gas inlet 10.

The first diffusion control part 11 is a part providing predetermined diffusion resistance to the taken measurement gas.

The buffer space 12 is provided to cancel concentration fluctuations of the measurement gas caused by pressure fluctuations of the measurement gas in the external space. Pulsation of exhaust pressure of the exhaust gas of the vehicle is taken as an example of such pressure fluctuations of the measurement gas, for example.

The second diffusion control part 13 is a part providing predetermined diffusion resistance to the measurement gas introduced from the buffer space 12 into the first chamber 20.

The first chamber 20 is provided as a space to pump oxygen out of the measurement gas introduced through the second diffusion control part 13. Pumping-out of oxygen is implemented by operation of a first adjustment pump cell 21.

The first adjustment pump cell 21 is an electrochemical pump cell including a first inner pump electrode (first adjustment electrode) 22, an outer pump electrode (out-of-space pump electrode) 23, and a solid electrolyte present in a portion of the structure 14 sandwiched between these electrodes.

In the first adjustment pump cell 21, a voltage Vp0 is applied across the first inner pump electrode 22 and the outer pump electrode 23 from a variable power supply 24 disposed outside the sensor element 101 to generate an oxygen pump current (oxygen ion current) Ip0. Oxygen in the first chamber 20 can thereby be pumped out to the external space. Assume that a direction of the oxygen pump current Ip0 when oxygen is pumped out from the first chamber 20 is a positive direction of the oxygen pump current Ip0 in the present embodiment.

The first inner pump electrode 22 is provided on substantially the entire portions of the lower surface 6b of the second solid electrolyte layer 6 and the upper surface 4a of the first solid electrolyte layer 4 defining the first chamber 20 respectively as a ceiling electrode portion 22a and a bottom electrode portion 22b. The ceiling electrode portion 22a and the bottom electrode portion 22b are connected by an unillustrated conducting portion.

The first inner pump electrode 22 is provided as a porous cermet electrode containing at least one of platinum and rhodium (Rh) as a metal component and being rectangular in plan view.

The outer pump electrode 23 is provided, with platinum or an alloy (a Pt—Au alloy) of platinum and gold as a metal component, as a porous cermet electrode containing platinum or the Pt—Au alloy and zirconia and being rectangular in plan view, for example.

In the sensor element 101, the first inner pump electrode 22, a reference electrode 42, and a solid electrolyte present in a portion of the structure 14 sandwiched between these electrodes constitute a first chamber sensor cell 80. The first chamber sensor cell 80 is an electrochemical sensor cell to grasp oxygen partial pressure in an atmosphere in the first chamber 20.

The reference electrode 42 is an electrode formed between the first solid electrolyte layer 4 and the third substrate 3 and is provided as a porous cermet electrode containing platinum and zirconia and being rectangular in plan view, for example.

A reference gas introduction layer 48 formed of porous alumina and leading to the reference gas introduction space 43 is provided around the reference electrode 42. A reference gas in the reference gas introduction space 43 is introduced into a surface of the reference electrode 42 via the reference gas introduction layer 48. That is to say, the reference electrode 42 is always in contact with the reference gas.

In the first chamber sensor cell 80, electromotive force (Nernst electromotive force) V0 is generated between the first inner pump electrode 22 and the reference electrode 42. The electromotive force V0 has a value in accordance with a difference between an oxygen concentration (oxygen partial pressure) in the first chamber 20 and an oxygen concentration (oxygen partial pressure) of the reference gas. The oxygen concentration (oxygen partial pressure) of the reference gas is basically constant, so that the electromotive force V0 has a value in accordance with the oxygen concentration (oxygen partial pressure) in the first chamber 20.

The third diffusion control part 30 is a part providing predetermined diffusion resistance to the measurement gas introduced from the first chamber 20 into the second chamber 40, containing H₂O and CO₂, and substantially not containing oxygen. The second chamber 40 is provided as a space to reduce (decompose) H₂O and CO₂ contained as the sensing target gas components in the measurement gas introduced through the third diffusion control part 30 to generate hydrogen (H₂) and carbon monoxide (CO), so that the measurement gas does not substantially contain oxygen as well as H₂O and CO₂. Reduction (decomposition) of H₂O and CO₂ is implemented by operation of a second adjustment pump cell 50.

The second adjustment pump cell 50 is an electrochemical pump cell including a second inner pump electrode (second adjustment electrode) 51, the outer pump electrode 23, and a solid electrolyte present in a portion of the structure 14 sandwiched between these electrodes.

In the second adjustment pump cell 50, a voltage Vp1 is applied across the second inner pump electrode 51 and the outer pump electrode 23 from a variable power supply 52 disposed outside the sensor element 101 to generate an oxygen pump current (oxygen ion current) Ip1. Oxygen generated by reduction of H₂O and CO₂ in the second chamber 40 can thereby be pumped out to the external space. Assume that a direction of the oxygen pump current Ip1 when oxygen is pumped out from the second chamber 40 is a positive direction of the oxygen pump current Ip1 in the present embodiment.

The second inner pump electrode 51 is provided on substantially the entire portions of the lower surface 6b of the second solid electrolyte layer 6 and the upper surface 4a of the first solid electrolyte layer 4 defining the second chamber 40 respectively as a ceiling electrode portion 51a and a bottom electrode portion 51b. The ceiling electrode portion 51a and the bottom electrode portion 51b are connected by an unillustrated conducting portion.

The second inner pump electrode 51 is provided as a porous cermet electrode containing Pt as a metal component and being rectangular in plan view.

In the sensor element 101, the second inner pump electrode 51, the reference electrode 42, and a solid electrolyte present in a portion of the structure 14 sandwiched between these electrodes constitute a second chamber sensor cell 81. The second chamber sensor cell 81 is an electrochemical sensor cell to grasp oxygen partial pressure in an atmosphere in the second chamber 40.

In the second chamber sensor cell 81, electromotive force (Nernst electromotive force) V1 is generated between the second inner pump electrode 51 and the reference electrode 42. The electromotive force V1 has a value in accordance with a difference between an oxygen concentration (oxygen partial pressure) in the second chamber 40 and the oxygen concentration (oxygen partial pressure) of the reference gas. Since the oxygen concentration (oxygen partial pressure) of the reference gas is basically constant, the electromotive force V1 has a value in accordance with the oxygen concentration (oxygen partial pressure) in the second chamber 40.

The fourth diffusion control part 60 is a part providing predetermined diffusion resistance to the measurement gas introduced from the second chamber 40 into the third chamber 61 and containing H₂ and CO while substantially not containing H₂O, CO₂, and oxygen.

The third chamber 61 is provided as a space to oxidize all of H₂ and CO contained in the measurement gas introduced through the fourth diffusion control part 60 to generate H₂O and CO₂ again. Generation of H₂O and CO₂ by oxidation of H₂ and CO is implemented by operation of a first measurement pump cell 41a and a second measurement pump cell 41b.

The first measurement pump cell 41a is an electrochemical pump cell including a first measurement electrode 44a, the outer pump electrode 23, and a solid electrolyte present in a portion of the structure 14 sandwiched between these electrodes.

In the first measurement pump cell 41a, a voltage Vp2 is applied across the first measurement electrode 44a and the outer pump electrode 23 from a variable power supply 47a disposed outside the sensor element 101 to generate an oxygen pump current (oxygen ion current) Ip2. Oxygen can thereby be pumped into the third chamber 61 from the external space.

On the other hand, the second measurement pump cell 41b is an electrochemical pump cell including a second measurement electrode 44b, the outer pump electrode 23, and a solid electrolyte present in a portion of the structure 14 sandwiched between these electrodes.

In the second measurement pump cell 41b, a voltage Vp3 is applied across the second measurement electrode 44b and the outer pump electrode 23 from a variable power supply 47b disposed outside the sensor element 101 to generate an oxygen pump current (oxygen ion current) Ip3. Oxygen can thereby be pumped into the third chamber 61 from the external space.

Assume that a direction of the oxygen pump current Ip2 and the oxygen pump current Ip3 when oxygen is pumped out from the third chamber 61 is a positive direction of the oxygen pump current Ip2 and the oxygen pump current Ip3 in the present embodiment.

The first measurement electrode 44a and the second measurement electrode 44b are provided at locations equivalent to each other with respect to a flow of the measurement gas flowing into the third chamber 61 through the fourth diffusion control part 60. In FIG. 1, the first measurement electrode 44a is provided on substantially the entire portion of the lower surface 6b of the second solid electrolyte layer 6 defining the third chamber 61, and the second measurement electrode 44b is similarly provided on substantially the entire portion of the upper surface 4a of the first solid electrolyte layer 4 defining the third chamber 61, but locations of the electrodes are not limited to these locations.

The first measurement electrode 44a is provided, with a Pt—Au alloy as a metal component, as a porous cermet electrode containing the Pt—Au alloy and zirconia and being rectangular in plan view, for example. Thus, only H₂ is selectively oxidized at the first measurement electrode 44a and CO is not oxidized, even when H₂ and CO coexist in the third chamber 61. The Pt—Au alloy preferably has an Au concentration of 1 wt % or more and 50 wt % or less and more preferably has an Au concentration of 30 wt % or more and 50 wt % or less. In this case, a selective H₂ oxidation property, that is, a property that, when H₂ and CO coexist in the third chamber 61, only H₂ is selectively oxidized with oxygen pumped in by the first measurement pump cell 41a and CO is not oxidized, of the first measurement electrode 44a is more suitably developed.

On the other hand, the second measurement electrode 44b is provided as a porous cermet electrode containing Pt as a metal component and being rectangular in plan view. Thus, both H₂ and CO are oxidized at the second measurement electrode 44b when H₂ and CO coexist in the third chamber 61.

In the sensor element 101, the first measurement electrode 44a, the reference electrode 42, and a solid electrolyte present in a portion of the structure 14 sandwiched between these electrodes constitute a first measurement sensor cell 82a. The first measurement sensor cell 82a is an electrochemical sensor cell to grasp oxygen partial pressure in an atmosphere near the first measurement electrode 44a in the third chamber 61.

In the first measurement sensor cell 82a, electromotive force (Nernst electromotive force) V2 is generated between the first measurement electrode 44a and the reference electrode 42. The electromotive force V2 has a value in accordance with a difference between an oxygen concentration (oxygen partial pressure) near the first measurement electrode 44a in the third chamber 61 and the oxygen concentration (oxygen partial pressure) of the reference gas. Since the oxygen concentration (oxygen partial pressure) of the reference gas is basically constant, the electromotive force V2 has a value in accordance with the oxygen concentration (oxygen partial pressure) near the first measurement electrode 44a.

Furthermore, in the sensor element 101, the second measurement electrode 44b, the reference electrode 42, and a solid electrolyte present in a portion of the structure 14 sandwiched between these electrodes constitute a second measurement sensor cell 82b. The second measurement sensor cell 82b is an electrochemical sensor cell to grasp oxygen partial pressure in an atmosphere near the second measurement electrode 44b in the third chamber 61.

In the second measurement sensor cell 82b, electromotive force (Nernst electromotive force) V3 is generated between the second measurement electrode 44b and the reference electrode 42. The electromotive force V3 has a value in accordance with a difference between an oxygen concentration (oxygen partial pressure) near the second measurement electrode 44b in the third chamber 61 and the oxygen concentration (oxygen partial pressure) of the reference gas. Since the oxygen concentration (oxygen partial pressure) of the reference gas is basically constant, the electromotive force V3 has a value in accordance with the oxygen concentration (oxygen partial pressure) near the second measurement electrode 44b.

The sensor element 101 further includes an electrochemical sensor cell 83 including the outer pump electrode 23, the reference electrode 42, and a solid electrolyte present in a portion of the structure 14 sandwiched between these electrodes. Electromotive force Vref generated between the outer pump electrode 23 and the reference electrode 42 of the sensor cell 83 has a value in accordance with oxygen partial pressure of the measurement gas present outside the sensor element 101.

In addition to the foregoing, the sensor element 101 includes a heater part 70 playing a role in temperature adjustment of heating the sensor element 101 and maintaining the temperature thereof to enhance oxygen ion conductivity of the solid electrolyte forming the structure 14.

The heater part 70 mainly includes a heater electrode 71, a heater element 72, a heater lead 72a, a through hole 73, a heater insulating layer 74, and a heater resistance detection lead, which is not illustrated in FIG. 1. The heater element 72 is hereinafter also simply referred to as a heater 72.

The heater 72 is provided to be sandwiched between the second substrate 2 and the third substrate 3 from below and above and generates heat by being powered from outside through the heater electrode 71 provided on a lower surface 1b of the first substrate 1, the through hole 73, and the heater lead 72a. The heater 72 is buried over the entire region of a range from the buffer space 12 to the third chamber 61 and can heat the sensor element 101 to a predetermined temperature and, further, maintain the temperature.

The heater 72 is provided so that a temperature is highest near the first chamber 20 (near the first adjustment electrode 22) and decreases with increasing distance from the first chamber 20 in the longitudinal direction of the element during heating. In the present embodiment, a temperature in a range from the one end portion of the sensor element 101 in which the gas inlet 10 is disposed to the third chamber 61 when the gas sensor 100 is in use (when the sensor element 101 is driven) is referred to as an element driving temperature. The heater 72 performs heating so that the element driving temperature is in a range of 750° C. to 950° C.

The heater insulating layer 74 of alumina and the like is formed above and below the heater 72 to electrically insulate the heater 72 from the second substrate 2 and the third substrate 3. The heater part 70 also includes a pressure dissipation hole 75. The pressure dissipation hole 75 is a part provided to penetrate the third substrate 3 and communicate with the reference gas introduction space 43 and is provided to mitigate a rise in internal pressure associated with a rise in temperature in the heater insulating layer 74.

The gas sensor 100 further includes a controller 110 controlling operation of the sensor element 101 and performing processing to identify concentrations of the sensing target gas components based on currents flowing through the sensor element 101.

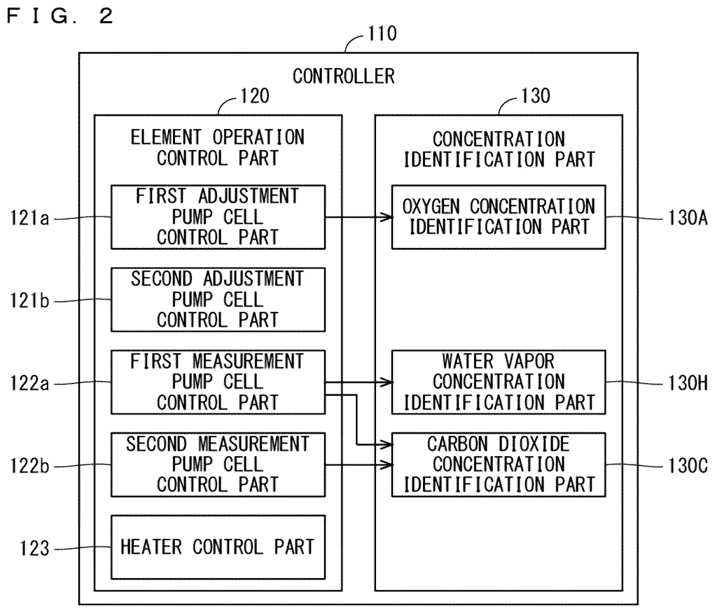

FIG. 2 is a block diagram showing functional components implemented by the controller 110. The controller 110 is configured by one or more electronic circuits including one or more central processing units (CPUs), a storage device, and the like, for example. Each of the electronic circuits is a software functional part implementing a predetermined functional component by a CPU executing a predetermined program stored in the storage device, for example. The controller 110 may naturally be configured by an integrated circuit, such as a field-programmable gate array (FPGA), on which a plurality of electronic circuits are connected in accordance with their functions and the like.

When the gas sensor 100 is attached to the exhaust path of the engine of the vehicle and is used with the exhaust gas flowing along the exhaust path as the measurement gas, some or all of functions of the controller 110 may be implemented by an electronic control unit (ECU) of the vehicle.

The controller 110 includes, as functional components implemented by the CPU executing a predetermined program, an element operation control part 120 controlling operation of each part of the sensor element 101 described above and a concentration identification part 130 performing processing to identify the concentrations of the sensing target gas components contained in the measurement gas.

The element operation control part 120 mainly includes a first adjustment pump cell control part 121a controlling operation of the first adjustment pump cell 21, a second adjustment pump cell control part 121b controlling operation of the second adjustment pump cell 50, a first measurement pump cell control part 122a controlling operation of the first measurement pump cell 41a, a second measurement pump cell control part 122b controlling operation of the second measurement pump cell 41b, and a heater control part 123 controlling heating operation performed by the heater 72.

On the other hand, the concentration identification part 130 mainly includes a water vapor concentration identification part 130H and a carbon dioxide concentration identification part 130C respectively identifying a concentration of H₂O and a concentration of CO₂ as the main sensing target gas components of the gas sensor 100. The water vapor concentration identification part 130H identifies the concentration of H₂O contained in the measurement gas based on a value of the oxygen pump current Ip2 flowing through the first measurement pump cell 41a acquired by the first measurement pump cell control part 122a.

The carbon dioxide concentration identification part 130C identifies the concentration of CO₂ contained in the measurement gas based on the value of the oxygen pump current Ip2 flowing through the first measurement pump cell 41a acquired by the first measurement pump cell control part 122a and a value of the oxygen pump current Ip3 flowing through the second measurement pump cell 41b acquired by the second measurement pump cell control part 122b.

The concentration identification part 130 further includes an oxygen concentration identification part 130A identifying a concentration of oxygen contained in the measurement gas. The oxygen concentration identification part 130A identifies the concentration of oxygen contained in the measurement gas based on a value of the oxygen pump current Ip0 flowing through the first adjustment pump cell 21 acquired by the first adjustment pump cell control part 121a. That is to say, the gas sensor 100 according to the present embodiment senses, in addition to H₂O and CO₂ as the main sensing target gas components, oxygen as an appendant sensing target gas component.

### <Multi-Gas Sensing and Concentration Identification>

A method of sensing a plurality of types of gases (multi-gas sensing) and identifying concentrations of the sensed gases implemented by the gas sensor 100 having a configuration as described above will be described next. Assume hereinafter that the measurement gas is an exhaust gas containing oxygen, H₂O, and CO₂.

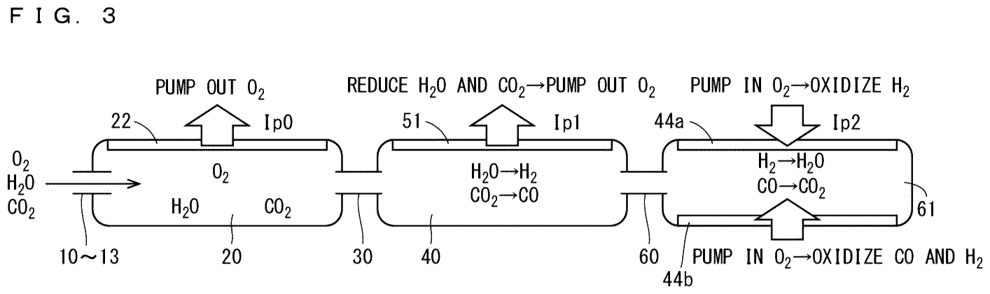

FIG. 3 is a schematic diagram illustrating entry and exit of gases into and from the three chambers (internal spaces) comprised in the sensor element 101 of the gas sensor 100.

First, in the sensor element 101 of the gas sensor 100 according to the present embodiment, the measurement gas is introduced through the gas inlet 10 (first diffusion control part 11), the buffer space 12, and the second diffusion control part 13 into the first chamber 20 as described above. In the first chamber 20, oxygen is pumped out of the introduced measurement gas by operation of the first adjustment pump cell 21.

Pumping-out of oxygen is performed in the way that the first adjustment pump cell control part 121a of the controller 110 sets a target value (control voltage) of the electromotive force V0 in the first chamber sensor cell 80 to a value in a range of 400 mV to 700 mV (preferably 400 mV) and feedback-controls the voltage Vp0 applied from the variable power supply 24 to the first adjustment pump cell 21 in accordance with a difference between an actual value and the target value of the electromotive force V0 so that the electromotive force V0 is maintained at the target value. A value of the electromotive force V0 significantly deviates from the target value when the measurement gas containing a large amount of oxygen reaches the first chamber 20, for example, and thus the first adjustment pump cell control part 121a controls the pump voltage Vp0 applied from the variable power supply 24 to the first adjustment pump cell 21 so that the deviation is reduced.

The first adjustment pump cell 21 pumps out oxygen from the first chamber 20 in such a manner, so that oxygen partial pressure in the first chamber 20 is maintained at a sufficiently low value to the extent that H₂O and CO₂ contained in the measurement gas are not reduced. It is approximately 10⁻⁸ atm when an equation V0=400 mV holds true, for example.

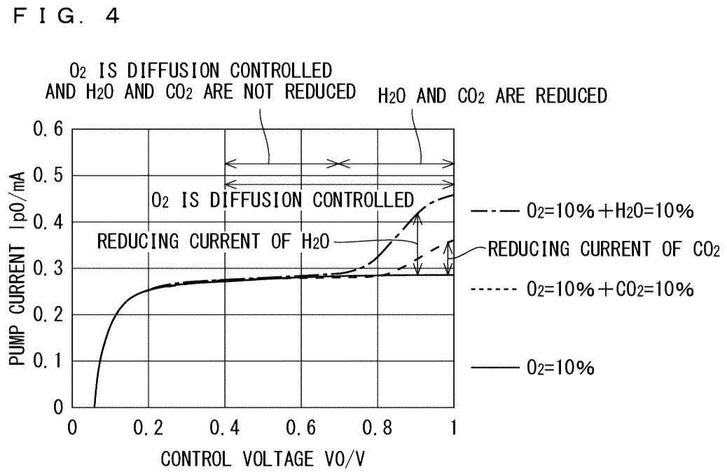

FIG. 4 is a diagram for describing a reason why oxygen is pumped out to the extent that H₂O and CO₂ are not reduced by setting the target value of the electromotive force V0 to the value in the range of 400 mV to 700 mV. Specifically, FIG. 4 is a graph showing a relationship between the target value (control voltage) of the electromotive force V0 in the first chamber sensor cell 80 and the oxygen pump current Ip0 flowing through the first adjustment pump cell 21 when three different types of model gases are caused to flow. Specifically, the three types of model gases include a first gas containing oxygen of 10%, a second gas containing oxygen of 10% and CO₂ of 10%, and a third gas containing oxygen of 10% and H₂O of 10%. The balance of each of the gases is nitrogen (N₂). The element driving temperature is 800° C., and a temperature of each of the model gases is 150° C.

It can be seen from FIG. 4 that, in a case of the first gas, the oxygen pump current Ip0 is substantially constant when the control voltage is in a range of 0.4 V or more, while, in a case of the second gas and the third gas, a profile is substantially the same as that for the first gas when the control voltage is in a range of 0.7 V or less but the oxygen pump current Ip0 increases again when the control voltage exceeds 0.7 V. The increase results from superimposition of reducing currents of H₂O or CO₂ flowing when H₂O or CO₂ contained in the measurement gas is reduced (decomposed) to generate oxygen.

As such, the target value of the electromotive force V0 is set to the value in the range of 400 mV to 700 mV in the present embodiment. In view of securing durability of the electrode, the electromotive force V0 is preferably as low as possible, and thus it is determined that the target value of the electromotive force V0 is preferably 400 mV.

As described above, in the gas sensor 100 according to the present embodiment, only pumping-out of oxygen to the extent that H₂O and CO₂ are not reduced is performed in the first chamber 20 to be at a highest temperature in the sensor element 101 during operation, and reduction of H₂O and CO₂ is not performed, in contrast to a gas sensor in conventional technology. The target value of the electromotive force V0 in the first chamber sensor cell 80 set for pumping-out is 400 mV to 700 mV, which is sufficiently smaller than a target value of 1000 mV to 1500 mV set when H₂O and CO₂ are reduced. An increase in pump voltage Vp0 is thus suppressed compared with a voltage applied to a corresponding pump cell in the gas sensor in conventional technology accompanied by reduction of H₂O and CO₂. Cracking and blackening attributable to application of a high voltage with the first inner pump electrode 22 being maintained at a high temperature are thus suitably suppressed in the gas sensor 100 according to the present embodiment.

The measurement gas of which only oxygen has been pumped out to the extent that H₂O and CO₂ are not reduced in the first chamber 20 is introduced into the second chamber 40. H₂O and CO₂ contained in the measurement gas are reduced in the second chamber 40. That is to say, oxygen is further pumped out of the measurement gas of which oxygen has been pumped out in the first chamber 20 and which is then introduced into the second chamber 40 by operation of the second adjustment pump cell 50, so that a reduction (decomposition) reaction (2H₂O→2H₂+O₂ and 2CO₂→2CO+O₂) of H₂O and CO₂ contained in the measurement gas progresses, and substantially all H₂O and CO₂ are decomposed into hydrogen (H₂), carbon monoxide (CO), and oxygen.

Reduction (decomposition) of H₂O and CO₂ and pumping-out of oxygen are performed in the way that the second adjustment pump cell control part 121b of the controller 110 sets a target value (control voltage) of the electromotive force V1 in the second chamber sensor cell 81 to a value in a range of 1000 mV to 1500 mV (preferably 1000 mV) and feedback-controls the voltage Vp1 applied from the variable power supply 52 to the second adjustment pump cell 50 in accordance with a difference between an actual value and the target value of the electromotive force V1 so that the electromotive force V1 is maintained at the target value. It is also suggested from the graph of FIG. 4 that the target value of the electromotive force V1 be preferably set to the value in the range of 1000 mV to 1500 mV.

The second adjustment pump cell 50 operates in this manner, so that oxygen partial pressure in the second chamber 40 is maintained at a much lower value than oxygen partial pressure in the first chamber 20. It is approximately 10-20 atm when an equation V1=1000 mV holds true, for example. The measurement gas thus no longer substantially contains H₂O, CO₂, and oxygen.

The measurement gas containing H₂ and CO while not substantially containing H₂O, CO₂, and oxygen is introduced into the third chamber 61.

In the third chamber 61, oxygen is pumped in by operation of the first measurement pump cell 41a and operation of the second measurement pump cell 41b.

Pumping-in of oxygen by the first measurement pump cell 41a is performed in the way that the first measurement pump cell control part 122a of the controller 110 sets a target value (control voltage) of the electromotive force V2 in the first measurement sensor cell 82a to a value in a range of 250 mV to 450 mV (preferably 350 mV) and feedback-controls the voltage Vp2 applied from the variable power supply 47a to the first measurement pump cell 41a in accordance with a difference between an actual value and the target value of the electromotive force V2 so that the electromotive force V2 is maintained at the target value.

The first measurement pump cell 41a operates in this manner, so that an oxidation (a combustion) reaction 2H₂+O₂→2H₂O is facilitated near the first measurement electrode 44a in the third chamber 61.

The reason why the target value of the electromotive force V2 is set to the value in the range of 250 mV to 450 mV is to selectively oxidize only H₂ from among the types of gases contained in the measurement gas present near the first measurement electrode 44a in the third chamber 61, and not to oxidize CO.

The amount of H₂O generated by pumping-in of oxygen by the first measurement pump cell 41a is hereinafter also referred to as a first H₂O amount.

Providing the first measurement electrode 44a as the cermet electrode containing the Pt—Au alloy having an Au concentration of 1 wt % or more and 50 wt % or less as the metal component as described above also contributes to improvement in selective H₂ oxidation property.

In the gas sensor in conventional technology, the cermet electrode containing the Pt—Au alloy is provided in the second chamber 40, and the pump cell including the electrode pumps in oxygen for selective oxidation of H₂, but, herein, the second inner pump electrode 51 not containing Au as the metal component is provided in the second chamber 40, and the first measurement electrode 44a similarly containing the Pt—Au alloy as the metal component and being responsible for selective oxidation of H₂ is provided to face the third chamber 61 at a lower temperature than the second chamber 40 during operation of the gas sensor 100. Thus, in the gas sensor 100 according to the present embodiment, evaporation of Au from the electrode is suppressed compared with that in the gas sensor in conventional technology.

In addition, any measures to devise a shape (a width and a thickness), placement (a density), and the like of the heater 72 may be taken to further suppress a rise in temperature of the first measurement electrode 44a.

On the other hand, pumping-in of oxygen by the second measurement pump cell 41 is performed in the way that the second measurement pump cell control part 122b of the controller 110 sets a target value (control voltage) of the electromotive force V3 in the second measurement sensor cell 82b to a value in a range of 100 mV to 300 mV (preferably 200 mV) and feedback-controls the voltage Vp3 applied from the variable power supply 47b to the second measurement pump cell 41b in accordance with a difference between an actual value and the target value of the electromotive force V3 so that the electromotive force V3 is maintained at the target value.

The second measurement pump cell 41b operates in this manner, so that an oxidation (a combustion) reaction 2CO+O₂→2CO₂ and an oxidation (a combustion) reaction 2H₂+O₂→2H₂O are both facilitated near the second measurement electrode 44b in the third chamber 61.

By the former reaction, CO₂ in an amount correlating with the amount of CO₂ introduced through the gas inlet 10 is generated again.

On the other hand, the amount of H₂O generated by the latter reaction (hereinafter also referred to as a second H₂O amount) is substantially equal to the above-mentioned first H₂O amount, which is because the first measurement electrode 44a and the second measurement electrode 44b are arranged in the third chamber 61 at the equivalent locations with respect to the flow of the measurement gas, and H₂ contained in the measurement gas introduced into the third chamber 61 is oxidized by these electrodes with an equal probability.

A total sum of the first H₂O amount and the second H₂O amount correlates with the amount of H₂O introduced through the gas inlet 10. In the present embodiment, the amount of H₂O or CO₂ in the correlating amount means that the amount of H₂O or CO₂ introduced through the gas inlet 10 and the amount of H₂O or CO₂ generated again by oxidation of H₂ or CO generated by decomposition of H₂O or CO₂ are the same or are within a certain error range allowable in terms of measurement accuracy.

In the gas sensor 100 according to the present embodiment operating in the above-mentioned manner, the concentration of H₂O and the concentration of CO₂ in the measurement gas are identified respectively based on the oxygen pump current Ip2 flowing through the first measurement pump cell 41a as a current generated by pumping-in of oxygen for selective oxidation of H₂ at the first measurement electrode 44a and the oxygen pump current Ip3 flowing through the second measurement pump cell 41b as a current generated by pumping-in of oxygen for oxidation of H₂ and CO at the second measurement electrode 44b. The oxygen pump current Ip2 and the oxygen pump current Ip3 during actual measurement using the gas sensor 100 are hereinafter also referred to as a selective oxidation current Ip2 and a double-oxidation current Ip3.

Specifically, the following relationship between concentration values CH and Cc as the concentrations of H₂O and CO₂ in the measurement gas and the selective oxidation current Ip2 and the double-oxidation current Ip3 is used. Herein, k₁ and k₂ are constants of proportionality.

$${C}_{H} = {k}_{1} \cdot Ip 2 \qquad ( 1 )$$

$${C}_{C} = {k}_{2} \cdot ( Ip 3 - Ip 2 ) \qquad ( 2 )$$

The equation (1) is based on assumption that there is a proportional relationship between the selective oxidation current Ip2 and the first H₂O amount, and there is a proportional relationship between ½ of the concentration value CH of H₂O in the measurement gas and the selective oxidation current Ip2 as the first H₂O amount and the second H₂O amount are substantially equal to each other.

The equation (2) is based on assumption that a contribution to oxidation of H₂ in the double-oxidation current Ip3 is equal to the selective oxidation current Ip2 as the first H₂O amount and the second H₂O amount are substantially equal to each other, a difference value Ip3−Ip2 thus corresponds to a contribution of oxygen pumped in by the second measurement pump cell 41b to oxidation of CO, and further there is a proportional relationship between the difference value Ip3-Ip2 and the concentration of CO₂ in the measurement gas.

Prior to use of the gas sensor 100, the constants of proportionality k₁ and k₂ are identified in advance using model gases having known concentrations. The equation (1) including the constant of proportionality k₁ is stored in the water vapor concentration identification part 130H of the controller 110. The equation (2) including the constant of proportionality k₂ is stored in the carbon dioxide concentration identification part 130C of the controller 110.

The selective oxidation current Ip2 and the double-oxidation current Ip3 have values in accordance with diffusion resistance provided to the measurement gas from the gas inlet 10 to the third chamber 61 of the sensor element 101. The constants of proportionality k₁ and k₂ thus strictly vary with each sensor element 101 of the gas sensor 100. The constants of proportionality k₁ and k₂ are thus preferably identified for each gas sensor 100. As for gas sensors 100 manufactured under the same condition and from the same lot, however, the constants of proportionality k₁ and k₂ acquired for one particular gas sensor 100 may be applied to another gas sensor 100 from the same lot when it is confirmed that an error is within tolerance.

When actual measurement is performed using the gas sensor 100, the measurement gas is introduced into the sensor element 101 heated to the element driving temperature, and the first adjustment pump cell 21, the second adjustment pump cell 50, the first measurement pump cell 41a, and the second measurement pump cell 41b operate in the above-mentioned manner. The water vapor concentration identification part 130H acquires the selective oxidation current Ip2 from the first measurement pump cell control part 122a and identifies a concentration of H₂O based on the equation (1).

The carbon dioxide concentration identification part 130C acquires a value of the selective oxidation current Ip2 from the first measurement pump cell control part 122a and acquires a value of the double-oxidation current Ip3 from the second measurement pump cell control part 122b. A concentration of CO₂ is identified based on the equation (2).

In the gas sensor 100 according to the present embodiment, the concentrations of H₂O and CO₂ in the measurement gas are identified as described above.

The concentration of oxygen is identified using the oxygen pump current Ip0 flowing through the first adjustment pump cell 21 in parallel with identification of the concentrations of H₂O and CO₂.

In the gas sensor 100 according to the present embodiment, oxygen is pumped out of the measurement gas introduced through the gas inlet 10 in the first chamber 20 by operation of the first adjustment pump cell 21 as described above. Oxygen is pumped out to the extent that H₂O and CO₂ are not reduced, and the oxygen pump current Ip0 (hereinafter also referred to as an oxygen detection current Ip0) flowing in this case is substantially proportional to the concentration of oxygen contained in the measurement gas introduced through the gas inlet 10. That is to say, there is a linear relationship between the oxygen detection current Ip0 and the concentration of oxygen in the measurement gas. Data (Ip0-O₂ data) indicating the linear relationship is identified in advance using model gases having known oxygen concentrations and is stored in the controller 110.

During actual measurement using the gas sensor 100, the oxygen concentration identification part 130A acquires a value of the oxygen detection current Ip0 from the first adjustment pump cell control part 121a. A value of the concentration of oxygen corresponding to the acquired oxygen detection current Ip0 is identified with reference to the Ip0-O₂ data. The concentration of oxygen in the measurement gas is thereby identified.

As described above, in the gas sensor according to the present embodiment, the concentrations of H₂O and CO₂ can be measured when the measurement gas contains H₂O and CO₂ as in a conventional gas sensor. Furthermore, the concentration of oxygen can also accurately be obtained.

In addition, in a case of the gas sensor according to the present embodiment, H₂O and CO₂ are not reduced in the first chamber to be at a highest temperature during operation in contrast to the gas sensor in conventional technology, so that a voltage applied to the adjustment pump cell pumping out oxygen from the first chamber is suppressed to be lower than that in the gas sensor in conventional technology, thereby to suitably suppress cracking and blackening of the sensor element.

An electrode disposed in a chamber as an electrode containing a Pt—Au alloy as a metal component is only the second measurement electrode provided in the third chamber, and the electrode containing the Pt—Au alloy is not provided in the first chamber and the second chamber to be at a higher temperature than the third chamber, so that evaporation of Au from the electrode is suppressed compared with that in conventional technology.

That is to say, according to the present embodiment, a multi-gas sensor with more long-term reliability than before is implemented.

### <Modifications of Electrode Arrangement>

As described above, in the third chamber 61, the first measurement electrode 44a and the second measurement electrode 44b are required to be arranged at the equivalent locations with respect to the flow of the measurement gas due to the need for H₂ contained in the measurement gas to be oxidized with an equal probability at these electrodes.

In the above-mentioned embodiment, the first measurement electrode 44a and the second measurement electrode 44b are respectively arranged on the lower surface 6b of the second solid electrolyte layer 6 to be a ceiling surface of the third chamber 61 and the upper surface 4a of the first solid electrolyte layer 4 to be a bottom surface of the third chamber 61 as a pair of surfaces along the longitudinal direction of the sensor element 101 defining the third chamber 61 as illustrated in FIG. 1, but the electrodes may be arranged at locations different from those shown in FIG. 1 as long as the locations are equivalent with respect to the flow of the measurement gas.

For example, the locations of the first measurement electrode 44a and the second measurement electrode 44b shown in FIG. 1 may be switched.

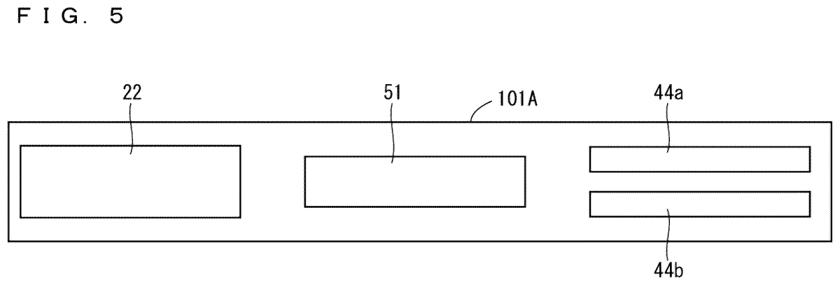

Alternatively, the first measurement electrode 44a and the second measurement electrode 44b may be arranged opposite each other on two exposed surfaces of the spacer layer 5 to be side portions of the third chamber 61 as a pair of surfaces along the longitudinal direction of the sensor element 101 similarly defining the third chamber 61. FIGS. 5 to 7 are diagrams illustrating sensor elements 101A to 101C in which the first measurement electrode 44a and the second measurement electrode 44b are arranged in different manners. FIGS. 5 to 7 illustrate planar arrangement relationships between the first measurement electrode 44a and the second measurement electrode 44b in the sensor elements 101A to 101C. While the first inner pump electrode 22 and the second inner pump electrode 51 are also illustrated for reference, these electrodes are assumed to be arranged at the same locations as those in a case of FIG. 1.

In the sensor element 101A illustrated in FIG. 5, the first measurement electrode 44a and the second measurement electrode 44b each having a longitudinal direction coinciding with the longitudinal direction of the element are arranged in parallel to be spaced apart from each other in a direction perpendicular to the longitudinal direction of the element. They may be arranged on any of the lower surface 6b of the second solid electrolyte layer 6 to be the ceiling surface of the third chamber 61 and the upper surface 4a of the first solid electrolyte layer 4 to be the bottom surface of the third chamber 61.

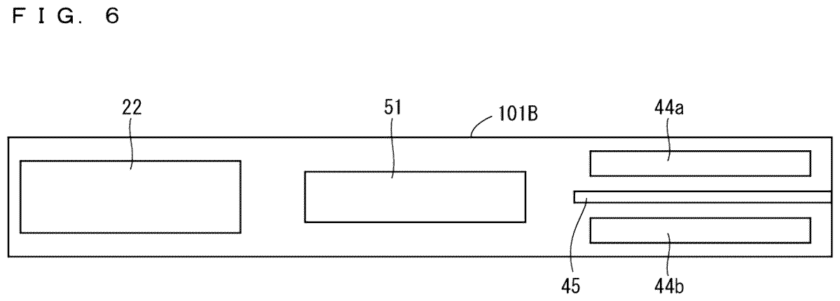

In the sensor element 101B illustrated in FIG. 6, a partition 45 is provided between the first measurement electrode 44a and the second measurement electrode 44b arranged at the same locations as those in the sensor element 101A. The partition 45 is a part protruding from a surface on which the first measurement electrode 44a and the second measurement electrode 44b have been formed to have a predetermined height. When the partition 45 is provided, arrival of Au evaporated from the first measurement electrode 44a at the second measurement electrode 44b and adherence thereto are suitably suppressed.

The partition 45 may be formed of a solid electrolyte as with the structure 14 and may be formed of alumina and other ceramics.

Complete bisection of the third chamber 61 by the partition 45 is not preferable because CO entering into a side on which the first measurement electrode 44a is disposed resides and is less likely to be oxidized by the second measurement electrode 44b.

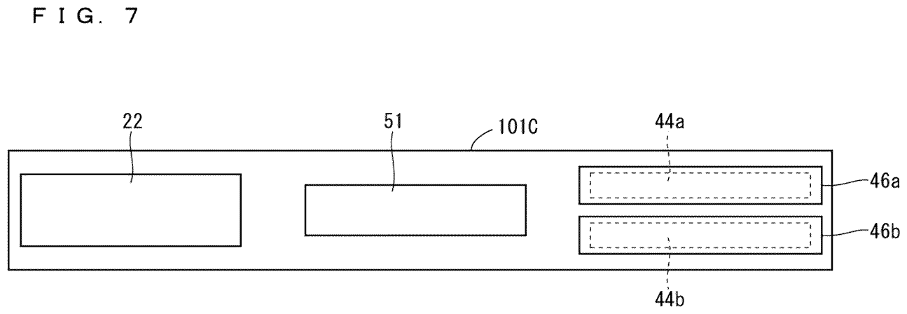

In the sensor element 101C illustrated in FIG. 7, the first measurement electrode 44a and the second measurement electrode 44b arranged at the same locations as those in the sensor element 101A are respectively covered with a porous body 46a and a porous body 46b of ceramics. The porous bodies 46a and 46b are provided also to suppress arrival of Au evaporated from the first measurement electrode 44a at the second measurement electrode 44b and adherence thereto.

The porous bodies 46a and 46b are provided to have an equal porosity in a range of 5% to 30% and an equal thickness in a range of 30 μm to 100 μm, for example.

Alternatively, the porosity and the thickness may further suitably be adjusted to provide a function of the fourth diffusion control part 60 to the porous bodies 46a and 46b, thereby to eliminate the fourth diffusion control part 60.

### Other Modifications

In the gas sensor 100 according to the above-mentioned embodiment, the sensor element 101 includes the gas distribution part including the first chamber 20, the second chamber 40, and the third chamber 61 communicating via the diffusion control parts. With respect to the measurement gas introduced sequentially into the chambers of the gas distribution part under predetermined diffusion resistance, the first adjustment pump cell 21 pumps out oxygen to the extent that H₂O and CO₂ are not reduced in the first chamber 20, the second adjustment pump cell 50 is used to reduce H₂O and CO₂ in the second chamber 40, and the first measurement pump cell 41a is used to selectively oxidize H₂ generated by reduction of H₂O and the second measurement pump cell 41b is used to oxidize H₂ generated by reduction of H₂O and CO generated by reduction of CO₂ in the third chamber 61. As a result, the concentrations of H₂O and CO₂ and further the concentration of oxygen in the measurement gas are measured based on the magnitudes of the currents flowing through the respective pump cells.

Such measurement using the gas sensor 100 is considered to be implemented by suppression of a flow of the measurement gas from outside the element into the first chamber 20 using the first diffusion control part 11 and the second diffusion control part 13, suppression of a flow of the measurement gas in which oxygen remains from the first chamber 20 into the second chamber 40 using the third diffusion control part 30, and further suppression of a flow of the measurement gas in which H₂O and CO₂ remain from the second chamber 40 into the third chamber 61 using the fourth diffusion control part 60. That is to say, it can be said that the measurement gas reaching the first inner pump electrode 22 of the first adjustment pump cell 21, the second adjustment electrode 51 of the second adjustment pump cell 50, the first measurement electrode 44a of the first measurement pump cell 41a, and the second measurement electrode 44b of the second measurement pump cell 41b is suitably controlled by the respective diffusion control parts so that gases not targeted for operation in the respective pump cells do not reach the respective electrodes, thereby to enable multi-gas sensing using the gas sensor 100.

Viewed another way, this means that a configuration different from the configuration of the gas distribution part of the sensor element 101 can be adopted as long as pumping-out of oxygen to the extent that H₂O and CO₂ are not reduced using the first adjustment pump cell 21, reduction of H₂O and CO₂ using the second adjustment pump cell 50, and selective oxidation of H₂ generated by reduction of H₂O using the first measurement pump cell 41a and oxidation of H₂ generated by reduction of H₂O and CO generated by reduction of CO₂ using the second measurement pump cell 41b with respect to the measurement gas reaching the first inner pump electrode 22, the second inner pump electrode 51, and the first measurement electrode 44a and the second measurement electrode 44b are performed successfully in view of securing measurement accuracy. For example, even a configuration in which the three chambers communicating via the diffusion control parts are not included can be adopted to implement multi-gas sensing.

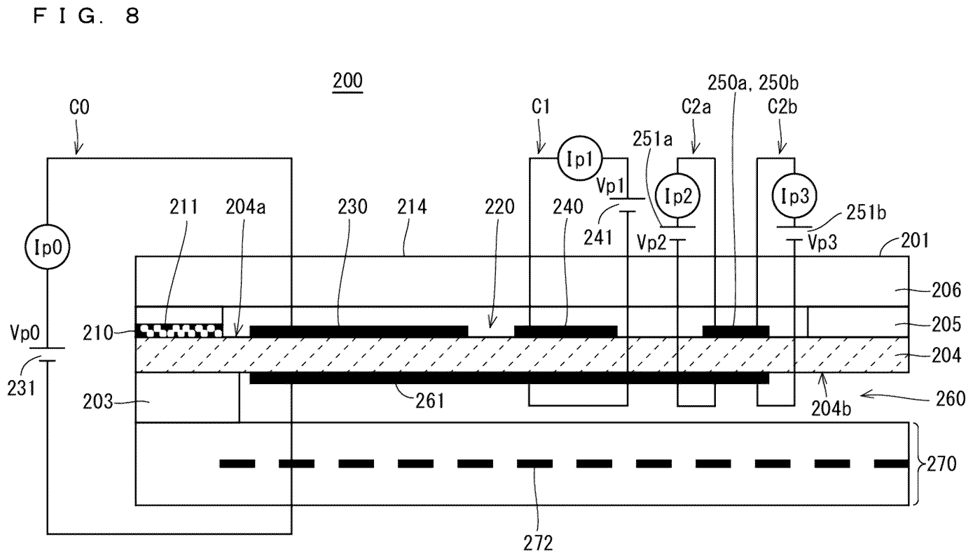

FIG. 8 is a diagram schematically showing one example of a configuration of a gas sensor 200 according to a modification with the foregoing in mind. The gas sensor 200 is a multi-gas sensor sensing a plurality of types of gas components and measuring concentrations thereof using a sensor element 201. In the gas sensor 200, control performed by the controller 110 enables multi-gas sensing with at least water vapor (H₂O) and carbon dioxide (CO₂) as main sensing target gas components as described below as in the gas sensor 100. FIG. 8 includes a vertical cross-sectional view taken along a longitudinal direction of the sensor element 201.

The sensor element 201 is an elongated planar structure including a laminate of a sensor part 214 and a heater part 270.

The sensor part 214 is formed by laminating a plurality of substrate layers of ceramics. Specifically, the sensor part 214 has a configuration in which four layers including a first substrate 203, a second substrate 204, a third substrate 205, and a fourth substrate 206 are sequentially laminated from the bottom. From among them, at least the second substrate 204 is formed of an oxygen-ion conductive solid electrolyte, such as zirconia. The first substrate 203, the third substrate 205, and the fourth substrate 206 may be formed of a solid electrolyte or may be formed of an insulating material, such as alumina. In the sensor part 214, the first substrate 203 is adjacent to the heater part 270.

A gas inlet 210 through which a measurement gas is introduced is provided in one end portion (a left end portion in the figure) of the sensor part 214. More specifically, a diffusion control part 211 formed of a porous body having a porosity of approximately 10% to 50% is buried in one end portion of the third substrate 205, and an exposed portion in one end portion of the diffusion control part 211 is the gas inlet 210. The diffusion control part 211 has a length (size in the longitudinal direction of the element) of 0.5 mm to 1.0 mm, for example, a width (size in a transverse direction of the element) of 1.5 mm to 3 mm, for example, and a height (size in a thickness direction of the element) of 10 μm to 20 μm, for example.

The sensor part 214 also includes a single internal chamber 220 adjacent to the diffusion control part 211. The internal chamber 220 is formed to penetrate the third substrate 205 in the thickness direction. The internal chamber 220 has a length (size in the longitudinal direction of the element) of 6.0 mm to 12.0 mm, for example, a width (size in the transverse direction of the element) of 1.5 mm to 2.5 mm, for example, and a height (size in the thickness direction of the element) of 50 μm to 200 μm, for example.

That is to say, it can be said that the diffusion control part 211 and the internal chamber 220 constitute the gas distribution part communicating with the gas inlet 210 in the sensor element 201.

A first adjustment electrode 230, a second adjustment electrode 240, and a first measurement electrode 250a and a second measurement electrode 250b are provided on an exposed surface 204a of the second substrate 204 to the internal chamber 220 in a similar arrangement to the planar arrangement of the first inner pump electrode 22, the second inner pump electrode 51, and the first measurement electrode 44a and the second measurement electrode 44b in the sensor element 101A illustrated in FIG. 5. That is to say, the first adjustment electrode 230, the second adjustment electrode 240, and a set of the first measurement electrode 250a and the second measurement electrode 250b are arranged in order of proximity to the gas inlet 210 on a left side in the figure to face the internal chamber 220 while being spaced apart at predetermined intervals. The first adjustment electrode 230, the second adjustment electrode 240, the first measurement electrode 250a, and the second measurement electrode 250b are provided as porous cermet electrodes similar to the first inner pump electrode 22, the second inner pump electrode 51, the first measurement electrode 44a, and the second measurement electrode 44b of the sensor element 101.

The sensor part 214 further includes a reference gas introduction space 260 opening in the other end portion of the sensor element 201. The reference gas introduction space 260 is formed to penetrate the first substrate 203 in the thickness direction. Oxygen (O₂) and air are introduced into the reference gas introduction space 260 as reference gases, for example.

A reference electrode 261 is provided on an exposed surface 204b of the second substrate 204 to the reference gas introduction space 260. The reference electrode 261 is preferably provided over an entire range of arrangement of the first adjustment electrode 230, the second adjustment electrode 240, the first measurement electrode 250a, and the second measurement electrode 250b provided on the exposed surface 204a opposite the exposed surface 204b. The reference electrode 261 is provided as a porous cermet electrode containing platinum and zirconia and being rectangular in plan view, for example.

As with the heater part 70 of the sensor element 101, the heater part 270 is configured to heat the sensor element 201 to a predetermined temperature and, further, maintain the temperature by powering of the heater element 272 (also simply referred to as a heater 272) from outside the element. A configuration similar to the configuration of the heater part 70 of the sensor element 101 is applicable to the heater part 270. Alternatively, a configuration in which the heater element 272 is buried in an insulator may be used.

The heater 272 is provided so that a temperature is highest near the first adjustment electrode 230 and decreases with increasing distance from the first adjustment electrode 230 in the longitudinal direction of the element during heating.

In addition, the sensor element 201 includes a first adjustment pump cell C0, a second adjustment pump cell C1, a first measurement pump cell C2a, and a second measurement pump cell C2b.

The first adjustment pump cell C0 is an electrochemical pump cell including the first adjustment electrode 230, the reference electrode 261, and the second substrate 204 sandwiched between these electrodes. In the first adjustment pump cell C0, the voltage Vp0 is applied across the first adjustment electrode 230 and the reference electrode 261 from a variable power supply 231 disposed outside the sensor element 201 to generate the oxygen pump current (oxygen ion current) Ip0. Operation of the first adjustment pump cell C0 is controlled by the first adjustment pump cell control part 121a of the controller 110.

The second adjustment pump cell C1 is an electrochemical pump cell including the second adjustment electrode 240, the reference electrode 261, and the second substrate 204 sandwiched between these electrodes. In the second adjustment pump cell C1, the voltage Vp1 is applied across the second adjustment electrode 240 and the reference electrode 261 from a variable power supply 241 disposed outside the sensor element 201 to generate the oxygen pump current (oxygen ion current) Ip1. Operation of the second adjustment pump cell C1 is controlled by the second adjustment pump cell control part 121b of the controller 110.

The first measurement pump cell C2a is an electrochemical pump cell including the first measurement electrode 250a, the reference electrode 261, and the second substrate 204 sandwiched between these electrodes. In the first measurement pump cell C2a, the voltage Vp2 is applied across the first measurement electrode 250a and the reference electrode 261 from a variable power supply 251a disposed outside the sensor element 201 to generate the oxygen pump current (oxygen ion current) Ip2. Operation of the first measurement pump cell C2a is controlled by the first measurement pump cell control part 122a of the controller 110.

The second measurement pump cell C2b is an electrochemical pump cell including the second measurement electrode 250b, the reference electrode 261, and the second substrate 204 sandwiched between these electrodes. In the second measurement pump cell C2b, the voltage Vp3 is applied across the second measurement electrode 250b and the reference electrode 261 from a variable power supply 251b disposed outside the sensor element 201 to generate the oxygen pump current (oxygen ion current) Ip3. Operation of the second measurement pump cell C2b is controlled by the second measurement pump cell control part 122b of the controller 110.

As described above, in the sensor element 201, the first adjustment electrode 230, the second adjustment electrode 240, the first measurement electrode 250a, and the second measurement electrode 250b are arranged in the single internal chamber 220 in contrast to the sensor element 101 of the gas sensor 100. Nevertheless, the diffusion control part 211 and the internal chamber 220 are provided on a condition as described above to suitably provide diffusion resistance to the measurement gas introduced into the internal chamber 220, in other words, to suitably control a flow rate of the measurement gas, and therefore, multi-gas sensing with at least water vapor (H₂O) and carbon dioxide (CO₂) as the main sensing target gas components is enabled also in the gas sensor 200 including the sensor element 201 under control performed by the controller 110 as in the gas sensor 100.

Specifically, the measurement gas introduced from the gas inlet 210 into the internal chamber 220 through the diffusion control part 211 sequentially reaches the first adjustment electrode 230, the second adjustment electrode 240, and the set of the first measurement electrode 250a and the second measurement electrode 250b. The first adjustment pump cell C0 performs operation to pump oxygen out of the measurement gas having reached the first adjustment electrode 230 to the extent that H₂O and CO₂ are not reduced. The second adjustment pump cell C1 performs operation to pump out oxygen to reduce H₂O and CO₂ contained in the measurement gas having reached the second adjustment electrode 240. The first measurement pump cell C2a performs operation to pump in oxygen to selectively oxidize H₂ generated by reduction of H₂O performed by the second adjustment pump cell C1 and having reached the first measurement electrode 250a. The second measurement pump cell C2b performs operation to pump in oxygen to oxidize H₂ generated by reduction of H₂O and C0 generated by reduction of CO₂ performed by the second adjustment pump cell C1 and having reached the second measurement electrode 250b.

In this case, the measurement gas flows at a flow rate at which the measurement gas of which oxygen has not been pumped out does not pass through the first adjustment electrode 230 and the measurement gas in which H₂O and CO₂ remain does not pass through the second adjustment electrode 240, so that a current flowing through each pump cell is equivalent to a current flowing through each pump cell of the gas sensor 100. Thus, in the gas sensor 200, the water vapor concentration identification part 130H, the carbon dioxide concentration identification part 130C, and further the oxygen concentration identification part 130A can accurately identify the concentrations of H₂O, CO₂, and further oxygen in the measurement gas as in the gas sensor 100.

What is claimed is:

1. A gas sensor capable of measuring concentrations of a plurality of sensing target gas components contained in a measurement gas, the measurement gas at least containing water vapor and carbon dioxide, the gas sensor comprising:
a sensor element having a structure formed of an oxygen-ion conductive solid electrolyte; and
a controller controlling operation of the gas sensor, wherein
the sensor element comprises:
a gas inlet through which the measurement gas is introduced;
an internal chamber communicating with the gas inlet via a diffusion control part;
a first adjustment electrode, a second adjustment electrode, and a set of a first measurement electrode and a second measurement electrode each provided to face the internal chamber and arranged in order of proximity to the gas inlet while being spaced apart at predetermined intervals, the first measurement electrode and the second measurement electrode being provided at locations equivalent to each other with respect to a flow of the measurement gas flowing into the internal chamber;
a first adjustment pump cell including the first adjustment electrode, an out-of-space pump electrode provided at a location other than a location in the internal chamber, and a portion of the solid electrolyte present between the first adjustment electrode and the out-of-space pump electrode;
a second adjustment pump cell including the second adjustment electrode, the out-of-space pump electrode, and a portion of the solid electrolyte present between the second adjustment electrode and the out-of-space pump electrode;
a first measurement pump cell including the first measurement electrode, the out-of-space pump electrode, and a portion of the solid electrolyte present between the first measurement electrode and the out-of-space pump electrode;
a second measurement pump cell including the second measurement electrode, the out-of-space pump electrode, and a portion of the solid electrolyte present between the second measurement electrode and the out-of-space pump electrode; and
a heater heating the sensor element,
the first measurement electrode is a cermet electrode containing a Pt—Au alloy as a metal component,
the heater heats the sensor element so that a temperature is highest near the first adjustment electrode in the internal chamber and decreases with increasing distance from the first adjustment electrode in a longitudinal direction of the sensor element,
the first adjustment pump cell pumps oxygen out of the measurement gas having reached the first adjustment electrode through the gas inlet to the extent that water vapor and carbon dioxide contained in the measurement gas are not decomposed,
the second adjustment pump cell pumps oxygen out of the measurement gas having reached the second adjustment electrode so that substantially all water vapor and carbon dioxide contained in the measurement gas of which oxygen has been pumped out by the first adjustment pump cell are reduced,
the first measurement pump cell pumps oxygen into the internal chamber to selectively oxidize, near the first measurement electrode, hydrogen generated by reduction of water vapor and contained in the measurement gas having reached the first measurement electrode,
the second measurement pump cell pumps oxygen into the internal chamber to oxidize, near the second measurement electrode, hydrogen and carbon monoxide respectively generated by reduction of water vapor and carbon dioxide and contained in the measurement gas having reached the second measurement electrode, and
the controller identifies:
a concentration of water vapor contained in the measurement gas based on a value of a selective oxidation current as an oxygen pump current flowing between the first measurement electrode and the out-of-space pump electrode when hydrogen near the first measurement electrode is selectively oxidized by the first measurement pump cell pumping in oxygen; and
a concentration of carbon dioxide contained in the measurement gas based on the value of the selective oxidation current and a value of a double-oxidation current as an oxygen pump current flowing between the second measurement electrode and the out-of-space pump electrode when hydrogen and carbon monoxide near the second measurement electrode are oxidized by the second measurement pump cell pumping in oxygen.

2. The gas sensor according to claim 1, wherein
the internal chamber includes a first chamber, a second chamber, and a third chamber communicating sequentially in order of proximity to the gas inlet via different diffusion control parts,
the first adjustment electrode is disposed in the first chamber,
the second adjustment electrode is disposed in the second chamber, and
the first measurement electrode and the second measurement electrode are disposed in the third chamber.

3. The gas sensor according to claim 2, wherein
the controller identifies:
the concentration of water vapor contained in the measurement gas based on a proportional relationship between the selective oxidation current and the concentration of water vapor contained in the measurement gas, the proportional relationship being identified in advance, and
the concentration of carbon dioxide contained in the measurement gas based on a proportional relationship between a difference value obtained by subtracting the selective oxidation current from the double-oxidation current and the concentration of carbon dioxide contained in the measurement gas, the proportional relationship being identified in advance.

4. The gas sensor according to claim 2, wherein
the Pt—Au alloy has an Au concentration of 1 wt % or more and 50 wt % or less.

5. The gas sensor according to claim 4, wherein
the first adjustment electrode and the second adjustment electrode are cermet electrodes containing Pt and not containing Au.

6. The gas sensor according to claim 2, wherein
the controller further identifies
a concentration of oxygen contained in the measurement gas based on a magnitude of a current flowing between the first adjustment electrode and the out-of-space pump electrode when the first adjustment pump cell pumps out oxygen from the first chamber.

7. The gas sensor according to claim 2, wherein
the first measurement electrode and the second measurement electrode are arranged opposite each other on a pair of surfaces along the longitudinal direction of the sensor element defining the third chamber.

8. The gas sensor according to claim 2, wherein
the first measurement electrode and the second measurement electrode are arranged in parallel to be spaced apart from each other in a direction perpendicular to the longitudinal direction of the sensor element on a surface along the longitudinal direction defining the third chamber.

9. A concentration measurement method of measuring concentrations of a plurality of sensing target gas components contained in a measurement gas using a gas sensor, the measurement gas at least containing water vapor and carbon dioxide, wherein
the gas sensor includes a sensor element having an elongated planar structure formed of an oxygen-ion conductive solid electrolyte,
the sensor element comprises:
a gas inlet through which the measurement gas is introduced;
an internal chamber communicating with the gas inlet via a diffusion control part;
a first adjustment electrode, a second adjustment electrode, and a set of a first measurement electrode and a second measurement electrode each provided to face the internal chamber and arranged in order of proximity to the gas inlet while being spaced apart at predetermined intervals, the first measurement electrode and the second measurement electrode being provided at locations equivalent to each other with respect to a flow of the measurement gas flowing into the internal chamber;
a first adjustment pump cell including the first adjustment electrode, an out-of-space pump electrode provided at a location other than a location in the internal chamber, and a portion of the solid electrolyte present between the first adjustment electrode and the out-of-space pump electrode;
a second adjustment pump cell including the second adjustment electrode, the out-of-space pump electrode, and a portion of the solid electrolyte present between the second adjustment electrode and the out-of-space pump electrode;
a first measurement pump cell including the first measurement electrode, the out-of-space pump electrode, and a portion of the solid electrolyte present between the first measurement electrode and the out-of-space pump electrode;
a second measurement pump cell including the second measurement electrode, the out-of-space pump electrode, and a portion of the solid electrolyte present between the second measurement electrode and the out-of-space pump electrode; and
a heater heating the sensor element,
the first measurement electrode is a cermet electrode containing a Pt—Au alloy as a metal component, and
the concentration measurement method using the gas sensor comprises:
a) heating, using the heater, the sensor element so that a temperature is highest near the first adjustment electrode in the internal chamber and decreases with increasing distance from the first adjustment electrode in a longitudinal direction of the sensor element;
b) pumping, using the first adjustment pump cell, oxygen out of the measurement gas having reached the first adjustment electrode through the gas inlet to the extent that water vapor and carbon dioxide contained in the measurement gas are not decomposed;
c) pumping, using the second adjustment pump cell, oxygen out of the measurement gas having reached the second adjustment electrode so that substantially all water vapor and carbon dioxide contained in the measurement gas of which oxygen has been pumped out using the first adjustment pump cell are reduced;
d) pumping, using the first measurement pump cell, oxygen into the internal chamber to selectively oxidize, near the first measurement electrode, hydrogen generated by reduction of water vapor and contained in the measurement gas having reached the first measurement electrode;
e) pumping, using the second measurement pump cell, oxygen into the internal chamber to oxidize, near the second measurement electrode, hydrogen and carbon monoxide respectively generated by reduction of water vapor and carbon dioxide and contained in the measurement gas having reached the second measurement electrode;
f) identifying a concentration of water vapor contained in the measurement gas based on a value of a selective oxidation current as an oxygen pump current flowing between the first measurement electrode and the out-of-space pump electrode when hydrogen near the first measurement electrode is selectively oxidized by pumping in oxygen using the first measurement pump cell; and
g) identifying a concentration of carbon dioxide contained in the measurement gas based on the value of the selective oxidation current and a value of a double-oxidation current as an oxygen pump current flowing between the second measurement electrode and the out-of-space pump electrode when hydrogen and carbon monoxide near the second measurement electrode are oxidized by pumping in oxygen using the second measurement pump cell.

10. The concentration measurement method using the gas sensor according to claim 9, wherein
the internal chamber includes a first chamber, a second chamber, and a third chamber communicating sequentially in order of proximity to the gas inlet via different diffusion control parts,
the first adjustment electrode is disposed in the first chamber,
the second adjustment electrode is disposed in the second chamber, and
the first measurement electrode and the second measurement electrode are disposed in the third chamber.

11. The concentration measurement method using the gas sensor according to claim 10, wherein
in the step f), the concentration of water vapor contained in the measurement gas is identified based on a proportional relationship between the selective oxidation current and the concentration of water vapor contained in the measurement gas, the proportional relationship being identified in advance, and
in the step g), the concentration of carbon dioxide contained in the measurement gas is identified based on a proportional relationship between a difference value obtained by subtracting the selective oxidation current from the double-oxidation current and the concentration of carbon dioxide contained in the measurement gas, the proportional relationship being identified in advance.

12. The concentration measurement method using the gas sensor according to claim 10, wherein
the Pt—Au alloy has an Au concentration of 1 wt % or more and 50 wt % or less.

13. The concentration measurement method using the gas sensor according to claim 12, wherein
the first adjustment electrode and the second adjustment electrode are cermet electrodes containing Pt and not containing Au.

14. The concentration measurement method using the gas sensor according to claim 10, further comprising
h) identifying a concentration of oxygen contained in the measurement gas based on a magnitude of a current flowing between the first adjustment electrode and the out-of-space pump electrode when oxygen is pumped out from the first chamber using the first adjustment pump cell.

15. The concentration measurement method using the gas sensor according to claim 10, wherein
the first measurement electrode and the second measurement electrode are arranged opposite each other on a pair of surfaces along the longitudinal direction of the sensor element defining the third chamber.

16. The concentration measurement method using the gas sensor according to claim 10, wherein
the first measurement electrode and the second measurement electrode are arranged in parallel to be spaced apart from each other in a direction perpendicular to the longitudinal direction of the sensor element on a surface along the longitudinal direction defining the third chamber.

17. The gas sensor according to claim 3, wherein
the first measurement electrode and the second measurement electrode are arranged opposite each other on a pair of surfaces along the longitudinal direction of the sensor element defining the third chamber.

18. The gas sensor according to claim 3, wherein
the first measurement electrode and the second measurement electrode are arranged in parallel to be spaced apart from each other in a direction perpendicular to the longitudinal direction of the sensor element on a surface along the longitudinal direction defining the third chamber.

19. The concentration measurement method using the gas sensor according to claim 11, wherein
the first measurement electrode and the second measurement electrode are arranged opposite each other on a pair of surfaces along the longitudinal direction of the sensor element defining the third chamber.

20. The concentration measurement method using the gas sensor according to claim 11, wherein
the first measurement electrode and the second measurement electrode are arranged in parallel to be spaced apart from each other in a direction perpendicular to the longitudinal direction of the sensor element on a surface along the longitudinal direction defining the third chamber.
